(19) United States
(12) Patent Application Publication
(10) Pub. No.: US 2007/0137691 A1
(43) Pub. Date: Jun. 21, 2007

(54) Light collector and concentrator

(76) Inventors: Joshua Monroe Cobb, Victor, NY (US); John H. Bruning, Pittsford, NY (US)

Correspondence Address: CORNING INCORPORATED, SP-TI-3-1, CORNING, NY, 14831, US

(21) Appl. No.: 11/640,725

(22) Filed: Dec. 18, 2006

Related U.S. Application Data
(60) Provisional application No. 60/778,080, filed on Feb. 28, 2006.
(60) Provisional application No. 60/751,810, filed on Dec. 19, 2005.

(51) Int. Cl. H02N 6/00

(52) U.S. Cl. 136/246

(57) ABSTRACT

An apparatus for obtaining radiant energy from a polychromatic radiant energy source has a spectral separator with a first curved surface concave to the incident radiant energy and treated to reflect a first spectral band toward a first focal region and to transmit a second spectral band and a second curved surface concave to the incident radiant energy and treated to reflect the second spectral band toward a second focal region. The first and second curved surfaces are optically positioned so that the first and second focal regions are spaced apart from each other. There are first and second light receivers, wherein the first light receiver is disposed nearest the first focal region for receiving the first spectral band and the second light receiver is disposed nearest the second focal region for receiving the second spectral band.

### CROSS REFERENCE TO RELATED APPLICATIONS

This application claims the benefit of U.S. Provisional Application Ser. No. 60/778,080 filed Feb. 28, 2006, entitled “Light Collector And Concentrator” by Cobb et al.

Reference is also made to U.S. Patent Application Ser. No. 60/751,810 filed Dec. 20, 2005, entitled “Method and Apparatus for Concentrating Light” by Cobb et al.

### STATEMENT REGARDING FEDERALLY SPONSORED RESEARCH OR DEVELOPMENT

This invention was made with government support under agreement w911nf-05-9-0005 awarded by the government. The government has certain rights in the invention

### FIELD OF THE INVENTION

This invention generally relates to apparatus for efficiently collecting and concentrating light, and more particularly relates to an apparatus that collects and separates light into two or more spectral bands, each directed toward a separate receiver.

### BACKGROUND OF THE INVENTION

Efficient collection and concentration of radiant energy is useful in a number of applications and is of particular value for devices that convert solar energy to electrical energy. Concentrator solar cells make it possible to obtain a significant amount of the sun's energy and concentrate that energy as heat or for generation of direct current from a photovoltaic receiver.

Large-scale light concentrators for obtaining solar energy typically include a set of opposed, curved mirrors, with a Cassegrain arrangement, as an optical system for concentrating light onto a receiver that is positioned at a focal point. As just a few examples employing the Cassegrain model, U.S. Pat. No. 5,979,438 entitled “Sunlight Collecting System” to Nakamura and U.S. Pat. No. 5,005,958 entitled “High Flux Solar Energy Transformation” to Winston et al. both describe large-scale solar energy systems using sets of opposed primary and secondary mirrors. As a more recent development for providing more compact collection apparatus, planar concentrators have been introduced, such as that described in the article entitled “Planar Concentrators Near the Etendue Limit” by Roland Winston and Jeffrey M. Gordon in Optics Letters, Vol. 30 no. 19, pp. 2617-2619. Planar concentrators similarly employ primary and secondary curved mirrors with a Cassegrain arrangement, separated by a dielectric optical material, for providing high light flux concentration.

FIG. 1 shows the basic Cassegrain arrangement for light collection. A photovoltaic apparatus 10 with an optical axis O has a parabolic primary mirror 12 and a secondary mirror 14 located at or near the focal point of primary mirror 12. A receiver 16 is then placed at the focal point of this optical system, at a vertex of primary mirror 12. A recognized problem with this architecture, a problem inherent to the Cassegrain model, is that secondary mirror 14 presents an obstruction to on-axis light, so that a portion of the light, nominally as much as about 10%, does not reach primary mirror 12, reducing the overall light-gathering capability of photovoltaic apparatus 10. This obscuration can be especially large if the concentrator is cylindrical instead of rotationally symmetric. Placement of receiver 16 at the vertex of primary mirror 12, in the path of the obstruction presented by secondary mirror 14, helps somewhat to mitigate losses caused by the obstruction. However, with a cylindrical optical configuration, little or none of this obstruction loss is gained back by making dimensional adjustments, since the size of the obstruction scales upwards proportionally with any increased size in primary mirror 12 diameter. This means that enlarging the diameter of the larger mirror does not appreciably change the inherent loss caused by the obstruction from the smaller mirror.

Some types of solar energy systems operate by converting light energy to heat. In various types of flat plate collectors and solar concentrators, concentrated sunlight heats a fluid traveling through the solar cell to high temperatures for power generation. An alternative type of solar conversion mechanism, more adaptable for use in thin panels and more compact devices, uses photovoltaic (PV) materials to convert sunlight directly into electrical energy. Photovoltaic materials may be formed from various types of silicon and other semiconductor materials and are manufactured using semiconductor fabrication techniques and provided by a number of manufacturers, such as Emcore Photovoltaics, Albuquerque, N. Mex., for example. While silicon is less expensive, higher performance photovoltaic materials are alloys made from elements such as aluminum, gallium, and indium, along with elements such as nitrogen and arsenic.

As is well known, sunlight is highly polychromatic, containing broadly distributed spectral content, ranging from ultraviolet (UV), through visible, and infrared (IR) wavelengths, each wavelength having an associated energy level, typically expressed in terms of electron-volts (eV). Not surprisingly, due to differing band-gap characteristics between materials, the response of any one particular photovoltaic material depends upon the incident wavelength. Photons having an energy level below the band gap of a material slip through. For example, red light photons (nominally around 1.9 eV) are not absorbed by high band-gap semiconductors. Meanwhile, photons having an energy level higher than the band gap for a material are absorbed. For example, the energy from violet light photons (nominally around 3 eV) is wasted as heat in a low band-gap semiconductor.

One strategy for obtaining higher efficiencies from photovoltaic materials is to form a stacked photovoltaic cell, also sometimes termed a multifunction photovoltaic device. These devices are formed by stacking multiple photovoltaic cells on top of each other. With such a design, each successive photovoltaic cell in the stack, with respect to the incident light source, has a lower band-gap energy. In a simple stacked photovoltaic device, for example, an upper photovoltaic cell, consisting of gallium arsenide (GaAs), captures the higher energy of blue light. A second cell, of gallium antimonide (GaSb), converts the lower energy infrared light into electricity. One example of a stacked photovoltaic device is given in U.S. Pat. No. 6,835,888 entitled “Stacked Photovoltaic Device” to Sano et al.

While stacked photovoltaics can provide some measure of improvement in overall efficiency, these multilayered devices can be costly to fabricate. There can also be restrictions on the types of materials that can be stacked together atop each other, making it difficult for such an approach to prove economical for a broad range of applications. Another approach is to separate the light according to wavelength into two or more spectral portions, and to concentrate each portion onto an appropriate photovoltaic receiver device, with two or more photovoltaic receivers arranged side by side. With this approach, photovoltaic device fabrication is simpler and less costly, and a wider variety of semiconductors can be considered for use. This type of solution requires supporting optics for both separating light into suitable spectral components and concentrating each spectral component onto its corresponding photovoltaic surface.

One proposed solution for simultaneously separating and concentrating light at sufficient intensity is described in a paper entitled “New Cassegrainian PV Module using Dichroic Secondary and Multijunction Solar Cells” presented at an International Conference on Solar Concentration for the Generation of Electricity or Hydrogen in May, 2005 by L. Fraas, J. Avery, H. Huang, and E. Shifman. In the module described, a curved primary mirror collects light and directs this light toward a dichroic hyperbolic secondary mirror, near the focal plane of the primary mirror. IR light is concentrated at a first photovoltaic receiver near the focal point of the primary mirror. The secondary mirror redirects near-visible light to a second photovoltaic receiver positioned near a vertex of the primary mirror. In this way, each photovoltaic receiver obtains the light energy for which it is optimized, increasing the overall efficiency of the solar cell system.

While the approach shown in the Fraas paper advantageously provides spectral separation and concentrates light using the same set of optical components, there are some significant limitations to the solution that it presents. A first problem relates to the overall losses due to obstruction, as were noted earlier. As another problem, the apparatus described by Fraas et al. has a limited field of view of the sky because it has a high concentration in each axis due to its rotational symmetry. Yet another drawback relates to the wide bandwidths of visible light provided to a single photovoltaic receiver. With many types of photovoltaic materials commonly used for visible light, an appreciable amount of the light energy would still be wasted using such an approach, possibly causing excessive heat.

Dichroic surfaces, such as are used for the hyperbolic mirror in the solution proposed in the Fraas paper, provide spectral separation of light using interference effects obtained from coatings formed from multiple overlaid layers having different indices of refraction and other characteristics. In operation, dichroic coatings reflect and transmit light as a function of incident angle and wavelength. As the incident angle varies, the wavelength of light that is transmitted or reflected by a dichroic surface also changes. Where a dichroic coating is used with incident light at angles beyond about +/−20 degrees from normal, undesirable spectral effects can occur, so that spectral separation of light, due to wavelength differences, is compromised at such higher angles.

There have been a number of light collector solutions employing dichroic surfaces for spectral splitting. For example, in an article entitled “Spectral Beam Splitting Technology for Increased Conversion Efficiency in Solar Concentrating Systems: A Review”, available online at www.sciencedirect.com, authors A. G. Imenes, and D. R. Mills provide a survey of solar collection systems, including some using dichroic surfaces. For example, the description of a tower reflector (FIG. 24 in the Imenes and Mills article) shows one proposed solution that employs a curved dichroic beamsplitter as part of the optics collection system. High incident angles of some portion of the light on this surface could render such a solution as less than satisfactory with respect to light efficiency. Similarly, U.S. Pat. No. 4,700,013 entitled “Hybrid Solar Energy Generating System” to Soule describes the use of a dichroic surface as a selective heat mirror. However, as noted in the Imenes article cited above, the approach shown in the Soule '013 patent exhibits substantial optical losses. Some of these losses relate to the high incident angles of light directed to the selective heat mirror that is used.

There are inherent problems with dichroic surface shape and placement for light focused from a parabolic mirror. A flat dichroic surface positioned near the focal region of a parabolic reflector would exhibit poor separation performance for many designs, constraining the dimensions of a light collection system. A properly curved dichroic surface, such as a hyperbolic surface, can be positioned at or near the focal region, but obstructs some portion of the available light, as noted earlier.

Conventional approaches for light concentration have been primarily directed to rotationally symmetrical optical systems using large-scale components. However, this approach may not yield satisfactory solutions for smaller solar panel devices. There exists a need for an anamorphic light concentrator that can be formed on a transparent body and fabricated in a range of sizes, where the light concentrator design allows it to be extended in a direction orthogonal to the direction of its highest optical power, whether extended linearly or extended along a curve.

Against obstacles such as poor dichroic surface response, conventional approaches have provided only a limited number of solutions for achieving, at the same time, both good spectral separation and efficient light flux concentration of each spectral component. The Cassegrain model can be optimized, but always presents an obstruction near the focal point of the primary mirror, and is thus inherently disadvantaged. Solutions that employ dichroic separation perform best where incident light angles on the dichroic surface are low with respect to normal; however, many proposed designs do not appear to give enough consideration to these spectral separation characteristics, resulting in poor separation or misdirected light.

Thus, it is recognized that there is a need for a photovoltaic cell that provides improved light concentration as well as for a cell that simultaneously provides both spectral separation and light concentration, that can be easily scaled for use in a thin panel design, that can be readily manufactured, that provides increased efficiency over conventional photovoltaic solutions, and that can operate with a substantial field of view in at least one axis along the traversal path of the sun's changing position across the sky.

### SUMMARY OF THE INVENTION

It is an object of the present invention to advance the art of light collection and spectral separation. With this object in mind, the present invention provides an apparatus for obtaining radiant energy from a polychromatic radiant energy source, the apparatus comprising:
a) a spectral separator comprising:
   (i) a first curved surface concave to the incident radiant energy and treated to reflect a first spectral band toward a first focal region and to transmit a second spectral band;
   (ii) a second curved surface concave to the incident radiant energy and treated to reflect the second spectral band toward a second focal region;
   wherein the first and second curved surfaces are optically positioned so that the first and second focal regions are spaced apart from each other;
and
b) first and second light receivers,
wherein the first light receiver is disposed nearest the first focal region for receiving the first spectral band and the second light receiver is disposed nearest the second focal region for receiving the second spectral band.

It is a feature of the present invention that it provides both spectral separation of light into at least two spectral bands and concentration of each separated spectral band onto a receiver.

It is an advantage of the present invention that it provides an efficient mechanism for concentrating radiant energy onto a photoreceiver.

It is a further advantage of the present invention that it reduces losses from obstruction, common to systems using the Cassegrain model.

It is a further advantage of the apparatus of the present invention that it provides a large collection aperture with respect to its thickness.

These and other objects, features, and advantages of the present invention will become apparent to those skilled in the art upon reading the following detailed description in conjunction with the drawings, wherein there is shown and described an illustrative embodiment of the invention.

### BRIEF DESCRIPTION OF THE DRAWINGS

FIG. 1 is a side view showing a conventional Cassegrain arrangement for light collection.

FIG. 2 is a side view of a double parabolic reflector in a light concentrator according to the present invention.

FIG. 3 is a side view showing light reflection from a first surface of the parabolic reflector.

FIG. 4 is a side view showing light reflection from a second surface of the parabolic reflector.

FIG. 5 is a side view showing optical axes and decentration of the first and second surfaces of the double parabolic reflector.

FIG. 6 is a side view showing spectral band separation by first and second surfaces of the double parabolic reflector.

FIG. 7 is a cross-sectional side view of an alternate embodiment with a dispersive front surface.

FIG. 8 is a perspective view showing the double parabolic reflector of a light concentrator in a cylindrical arrangement.

FIGS. 9A, 9B, and 9C are plan views of light directed to a photovoltaic receiver of the light concentrator at various angles.

FIG. 10 is a perspective view of an alternate embodiment additionally having optical power in an orthogonal direction.

FIGS. 11A and 11B are side and top views, respectively, of an alternate embodiment additionally having optical power in an orthogonal direction.

FIGS. 12A and 12B are perspective front and rear views, respectively, of paired double parabolic reflectors in a cylindrical arrangement.

FIG. 13 is a rear perspective view of a portion of an array of paired double parabolic reflectors in a cylindrical arrangement.

FIG. 14 is a perspective view of an array of light concentrators in one embodiment.

FIG. 15 is a side view showing misdirected light that may be lost in one embodiment.

FIG. 16 is a side view showing misdirected light, a portion of which may be lost in one embodiment.

FIGS. 17A, 17B, and 17C are rear perspective views showing light-handling behavior of the light concentrator of the present invention in a cylindrical embodiment, for incident light at different angles.

FIG. 18 is a schematic diagram in perspective, showing a solar energy apparatus with tracking to adapt to the changing position of the radiation source.

FIG. 19 is a perspective view of an alternate embodiment additionally having optical power in an orthogonal direction with a single receiver.

### DETAILED DESCRIPTION OF THE INVENTION

The present invention provides a light concentrator providing both enhanced spectral separation and a high degree of light flux concentration, exceeding the capabilities afforded by earlier approaches. The light concentrator of the present invention can be used as an optical component of a photovoltaic cell, embodied either as a discrete cell or as part of a photovoltaic cell array.

The figures referenced in this description illustrate the general concepts and key structures and components of the apparatus of the present invention. These figures are not drawn to scale and may exaggerate dimensions and relative placement of components for the sake of clarity. The spectral bands described herein are given by way of example and not of limitation.

As is well known, the light concentration that is obtained by a specific optical system depends on its overall geometry. For example, a perfect rotationally symmetrical paraboloid reflector would ideally direct light to a “focal point”. A cylindrical parabolic reflector, having optical power along only one axis, would ideally direct light to a “focal line”. However, as is familiar to those skilled in optical fabrication, only a reasonable approximation to such idealized geometric shapes can be realized in practice and neither a perfect focal point nor a perfect focal line are achievable or needed for efficient light concentration. Thus, instead of using the idealized “focal point” or “focal line” terminology, the description and claims of the present invention employ the more general term “focal region”. In subsequent description, the focal region for an optical structure is considered to be the spatial zone or vicinity of highest light concentration from that structure.

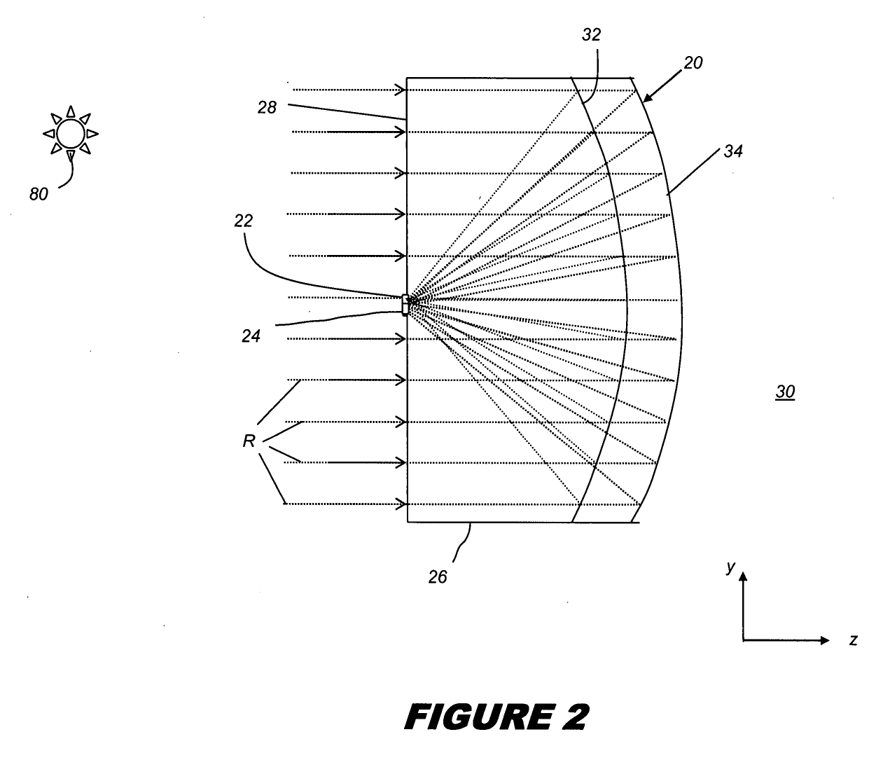

The side view cross section of FIG. 2 shows a light concentrator 30 for obtaining radiant energy from the sun 80 or other polychromatic light source. A double parabolic reflector 20 serves the functions of light collection, concentration, and spectral separation, having an inner or first concave curved reflective surface 32 and an outer or second concave curved reflective surface 34. Both first and second curved reflective surfaces 32 and 34 are substantially parabolic in cross section along at least one axis, and are arranged so that the light reflected from each curved reflective surface is concentrated about a different spatial region.

In the embodiments shown in FIGS. 2 through 19, light concentrator 30 can be formed on and within a body 26 of a generally transparent optical material, such as glass or other type of optical polymer such as plastic. Rays R of polychromatic light, such as sunlight or other highly polychromatic radiation, are incident on a front surface 28. Front surface 28 may be a treated surface, such as a coated surface, or may be featured, such as having a curvature or having a Fresnel lens structure or other lens formed or affixed thereon as a refracting feature, for example.

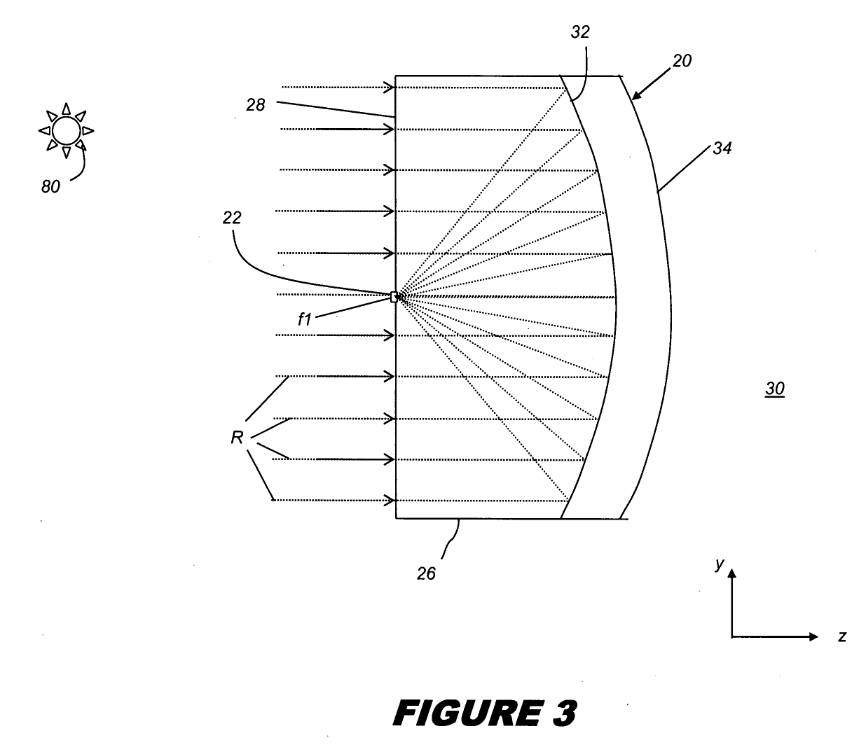

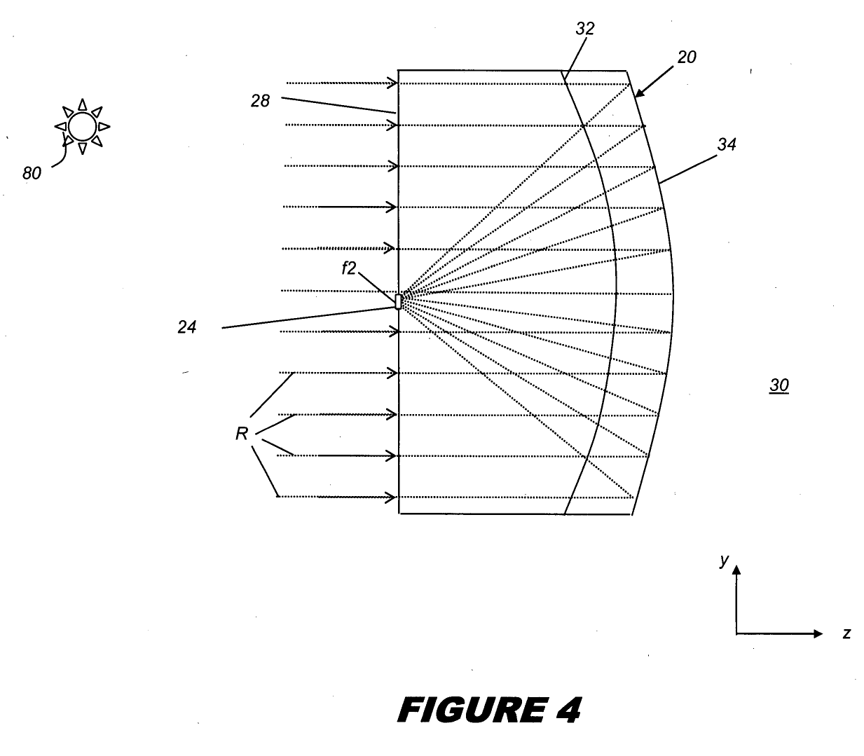

Light concentrator 30 can be considered as an apparatus that combines two different optical systems. The side view cross sections of FIGS. 3 and 4 show the light-separating behavior of each of the respective optical systems of double parabolic reflector 20. Referring first to FIG. 3, inner or first curved reflective surface 32, concave to the incident radiant energy, has a dichroic coating that reflects one spectral band of the incident light to a first light receiver 22, such as a photovoltaic (PV) receiver, located at or near the focal region f1 of first curved reflective surface 32. In one embodiment, first curved reflective surface 32 reflects shorter wavelengths, including visible and ultraviolet (UV) light, to first light receiver 22. Longer wavelengths, including infrared (IR) and near-infrared light are transmitted through first curved reflective surface 32.

As shown in FIG. 4, outer or second curved reflective surface 34, also concave to the incident radiant energy, reflects incident light toward a second light receiver 24 located at or near the focal region f2 of second curved reflective surface 34. In this embodiment, second curved reflective surface 34 acts as a mirror, reflecting the light that was transmitted through first curved reflective surface 32, that is, most of the infrared (IR) and near-infrared light.

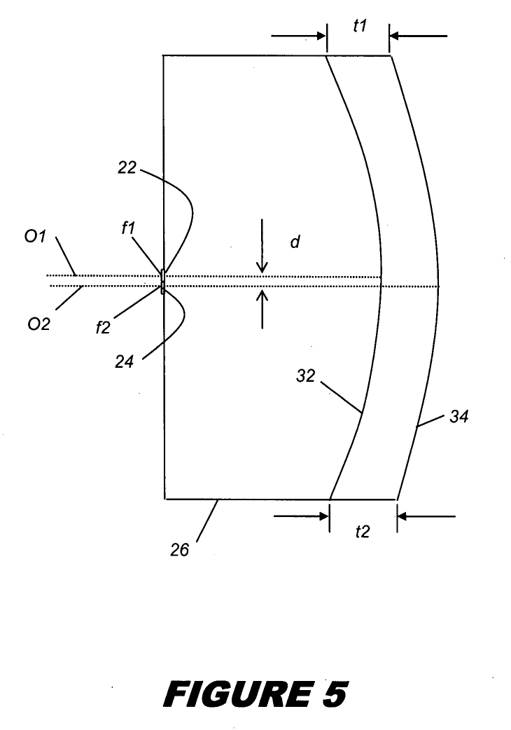

In order to better explain how double parabolic reflector 20 operates as a spectral separator, it is useful to describe how first and second curved reflective surfaces 32 and 34 can be arranged in a single assembly in a typical embodiment. The side view of FIG. 5 shows some important geometric and dimensional characteristics of double parabolic reflector 20 in a decentered embodiment. As is familiar to those skilled in the optical arts, a reflective surface that is parabolic in a plane has an optical axis in that plane and directs incident axial rays toward a focal point that lies on the optical axis. In double parabolic reflector 20, optical axis O1 is the optical axis of first curved reflective surface 32 in the plane of the cross-sectional view shown. Optical axis O2, corresponding to second curved reflective surface 34, is generally parallel to optical axis O1 in this decentered embodiment, but is not collinear with it. That is, axes O1 and O2 are noncollinear in this embodiment. This means that some non-zero distance d separates axes O1 and O2. First and second curved reflective surfaces 32′ and 34 are then optically decentered, with their respective focal points, represented within focal regions f1 and f2 in the cross-section view of FIG. 5, separated by distance d. This distance d is preferably equal to the center-to-center separation distance between light receivers 22 and 24, which are positioned at focal regions f1 and f2 respectively. With respect to each other, first and second light receivers 22 and 24 are disposed so that first light receiver 22 is disposed nearest the first focal region f1 of first curved reflective surface 32 and second light receiver 24 is disposed nearest the second focal region f2 of second curved reflective surface 34.

It should be noted that decentration of first and second curved reflective surfaces 32 and 34 is one possible embodiment and may be advantaged for manufacturability or for other reasons. However, the more generalized requirement for the present invention is that first and second curved reflective surfaces 32 and 34 be mutually disposed in some way so that there is a non-zero distance between focal regions f1 and f2. With reference to FIG. 5, optical axes O1 and O2 can be in parallel and noncollinear, as shown. Alternately, optical axes O1 and O2 could be non-parallel, where first and second curved reflective surfaces 32 and 34 are tilted with respect to each other in some way. As yet another alternative, optical axes O1 and O2 could even be collinear, with focal regions f1 and f2 disposed at different positions along the commonly shared axis. Such a collinear arrangement, while possible, would be disadvantaged for light collection however, since there would unavoidably be some shadowing of the light that is directed toward the further light receiver.

An important feature of double parabolic reflector 20 relates to the reflective treatments themselves. First curved reflective surface 32 has a dichroic coating in one embodiment so that it selectively reflects one spectral band and transmits another. In the embodiment described with reference to FIGS. 2 through 5, the dichroic coating of first curved reflective surface 32 is formulated to transmit some portion of visible red, near IR, and longer wavelengths, nominally longer than about 650 nm. Shorter wavelengths are then reflected by this dichroic coating. Thus, a shorter wavelength spectral band is directed toward light receiver 22 that is positioned near focal region f1. The reflective coating on outer or second curved reflective surface 34 is a mirror in this embodiment and may be a metallic coating, such as aluminum or suitable alloys, or may also be a dichroic coating or other suitable treatment. Dichroic coatings are particularly advantaged for high efficiency. As will be clearly evident to those skilled in the optical arts, alternate arrangements are possible, such as a dichroic coating that is treated to transmit visible light and shorter wavelengths through first curved reflective surface 32 and to reflect IR light, for example, with a reflective coating treated to reflect visible wavelengths from second curved reflective surface 34.

It is instructive to observe that light is preferably incident on first curved reflective surface 32 at angles that are relatively close to normal. When a dichroic coating is used, this arrangement provides the best dichroic performance. In this way, the apparatus of the present invention is advantaged over other types of light separators that use dichroic surfaces but direct incident light toward these surfaces at higher angles.

Because first and second curved reflective surfaces 32 and 34 may be decentered, tilted, or otherwise arranged in a non-symmetric fashion, the distance between these respective surfaces, taken in a direction parallel to optical axes O1, O2, may vary from the top to the bottom of double parabolic reflector 20. With reference to the embodiment of FIG. 5, for example, thickness t1 is less than thickness t2. This difference in thickness must be taken into account when stacking multiple double parabolic reflectors 20 in an array arrangement, as is described in more detail subsequently.

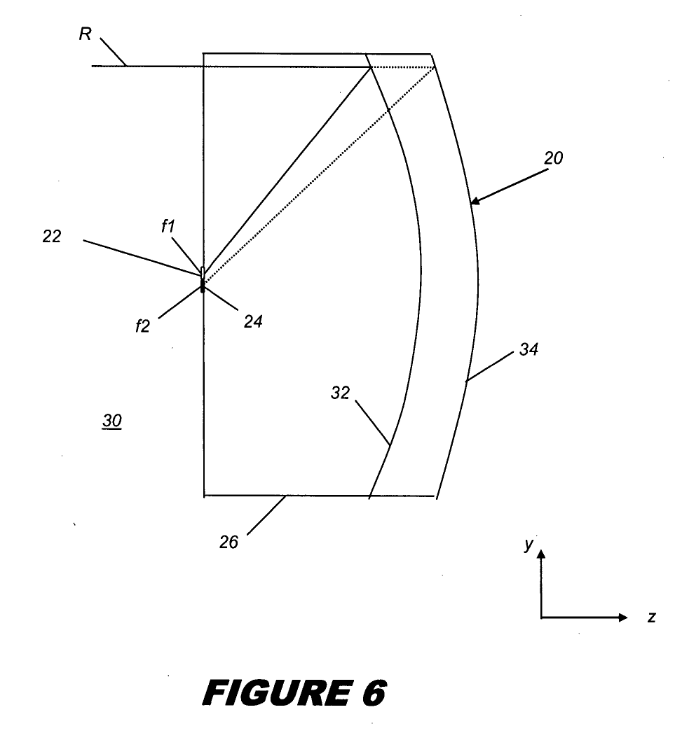

The cross-sectional side view of FIG. 6 summarizes, for a single incident ray R, how double parabolic reflector 20 acts as a spectral separator. Ray R is a polychromatic ray, such as a ray of sunlight, having a range of wavelengths. Shorter wavelengths, such as visible light, reflect from inner or first curved reflective surface 32 toward first light receiver 22 at focal region f1; longer wavelengths, such as near-IR and IR light, are reflected from second curved reflective surface 34 toward second light receiver 24 at focal region f2.

It is important to observe that body 26 has some refractive index n in embodiments of FIGS. 2 through 6. In the embodiments that use body 26 as described herein, this same refractive index n matches, or very closely matches, the refractive index of the material that lies between first and second curved reflective surfaces 32 and 34. This arrangement is advantaged for minimizing unwanted effects such as refraction at curved surface 32 and other possible problems that might result where materials having different refractive indices are used. For similar reasons, optical adhesives or other materials that bond light receivers 22 and 24 to body 26 also exhibit the same, or very nearly the same, index of refraction n. However, it should be observed that other arrangements are possible, including configurations where a material sandwiched between first and second curved reflective surfaces 32 and 34 has a different refractive index than other material of body 26. Alternately, first and second curved reflective surfaces 32 and 34 may be separated by air. Air may also lie between receivers 22, 24 and first curved surface 32.

Light concentrator 30 can be embodied with first and second curved reflective surfaces 32 and 34 having paraboloid shape, that is, with each surface rotationally symmetric about its axis. An embodiment of this type may use body 26, or may be in air, or may use some combination of transparent materials for body 26 and separation in air. Alternately, light concentrator 30 can be embodied with first and second curved reflective surfaces 32 and 34 having an anamorphic shape, that is, having one curvature in the YZ plane and a different curvature in the XZ plane.

For rotationally symmetric embodiments, cylindrical embodiments, or anamorphic embodiments, air may be used between inner or first curved reflective surface 32 and light receivers 22, 24 with transparent material used between first and second curved reflective surfaces 32 and 34. Alternately, transparent body 26 material could be used between inner or first curved reflective surface 32 and light receivers 22, 24 with air between first and second curved reflective surfaces32 and 34.

Alternate Embodiments with Dispersive Front Surface

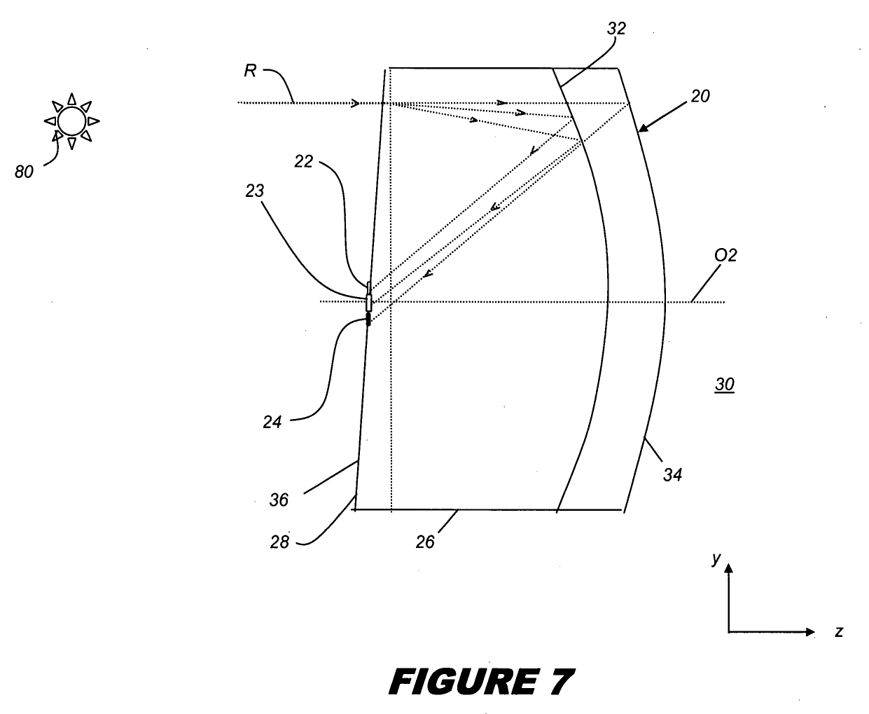

The double parabolic reflector described with reference to FIGS. 2 through 6 can also be used in combination with other mechanisms for spectral separation. In the alternate embodiment of FIG. 7, light concentrator 30 separates incident polychromatic radiation into three spectral bands, directing each spectral band to a suitable receiver 22, 23, or 24. Here, front surface 28 has a prism 36 or other suitable type of dispersive element in the path of incident radiation at front surface 28. As is well known to those skilled in the optical arts, the angle of refraction by a prism is a function of wavelength. In most optical materials, shorter wavelengths undergo a higher angular redirection in prism refraction than do longer wavelengths. Thus, for example, blue light has a relatively high refraction angle; longer red and IR wavelengths, on the other hand, have relatively low refraction angles. The refractive dispersion of an optical material is a measure of the difference in refraction between two wavelengths.

In FIG. 7, prism 36 lies in the path of incident radiation as shown by ray R and conditions the incident radiation by providing an amount of dispersion, forming a dispersed incident polychromatic radiant energy. The portion of visible light having shorter wavelengths (including, for example, blue light at around 480 nm), refracted at a higher angle, is then directed by first curved reflective surface 32 to a third light receiver 23. That portion of visible light having longer wavelengths (including, for example, orange light at around 620 nm) is refracted at a lesser angle by prism 36 and is directed by first curved reflective surface 32 to first light receiver 22. In this way, first curved reflective surface 32 reflects the same wavelengths as in the FIG. 6 embodiment, but effectively provides two spectral bands of this reflected light, directing one spectral band to first light receiver 22 and the other spectral band to third light receiver 23. IR light, which undergoes very little angular change due to dispersion, is again reflected from second curved reflective surface 34 and goes to second light receiver 24. Using this dispersive arrangement, light receivers 22 and 23 are positioned nearest the focal region of first curved reflective surface 32, whereas light receiver 24 is positioned nearest the focal region of second curved reflective surface 34.

Prism 36 can be attached to body 26 or otherwise optically coupled in the path of incident light. Optionally, prism 36 can be formed into front surface 28, so that front surface 28 is sloped or otherwise featured to provide a prism effect. Prism 36 may alternately be an array of dispersive elements, extended along the x direction according to the coordinate system of FIG. 7, where x is normal to the page. Other types of dispersive elements may alternately be used to provide the needed dispersion of incident light.

Cylindrical Embodiments

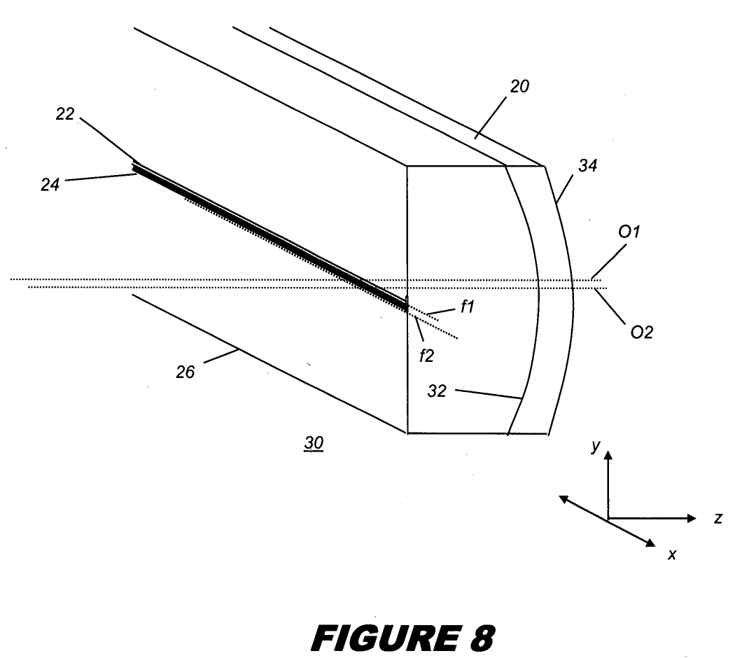

Referring to FIG. 8, there is shown a perspective view of a portion of light concentrator 30 in a cylindrical embodiment. Here, light concentrator 30 has optical power along an axis in the z-y plane, extending along the x direction, but may have no optical power in the x-z plane. The cross-sectional optical axes O1 and O2 for light concentrator 30 are generally parallel to the z axis coordinate in the embodiment shown. Focal regions f1 and f2 are linear, extending longitudinally along the cylindrical structure.

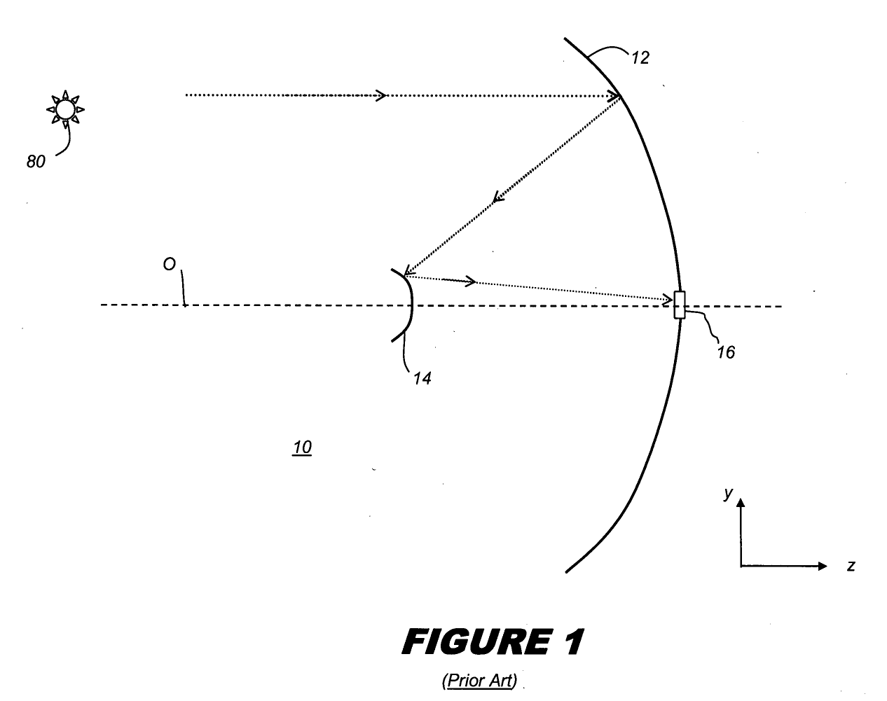

One significant advantage of light concentrator 30 can be observed from the perspective view of FIG. 8. The obscuration that is presented by light receivers 22 and 24 is relatively quite small, particularly when compared against the obscuration presented by the conventional Cassegrain arrangements described with reference to FIG. 1. In solar energy embodiments, the height of the image focused at each of focal regions f1 and f2 is the relative diameter of the image of the sun's disc, which, as viewed from the earth, has a mean angular diameter of only about 0.0092 radians, an angular extent of about 0.5 degree. Thus, the total height of the image formed at focal regions f1 and f2 is nominally twice the focused height of the sun's disc, still a relatively small dimension. Moreover, the effective aperture of light concentrator 30 can be increased by scaling or by increasing the parabolic extent of first and second curved reflective surfaces 32 and 34. Thus, a large aperture with respect to overall thickness can be obtained using the apparatus and methods of the present invention.

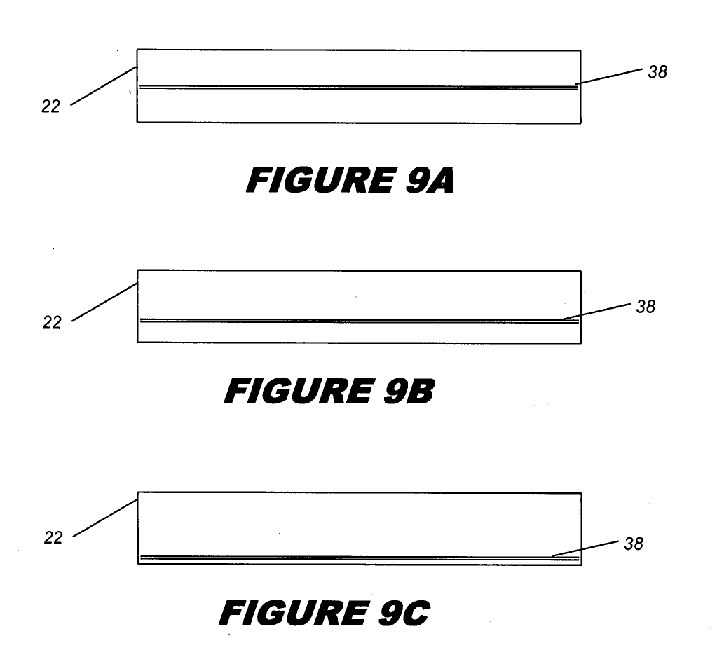

One advantage of the small image size that is formed at focal regions f1 and f2 relates to the relative size of light receivers 22 and 24. FIGS. 9A, 9B, and 9C show enlarged plan views of one light receiver 22 receiving a band of light 38 when the cylindrical embodiment of light concentrator 30 is used. Light receiver 22 can be dimensioned so that it is wider than the thickness of band of light 38 produced by light concentrator 30 optics. This would allow some tolerance for aiming error, as shown in FIGS. 9B and 9C, where imperfect alignment with radiation from the sun or other source still allows some amount of light energy to be obtained. There would, of course, be some penalty in terms of obscuration if light receiver 22 were increased in size. However, such a disadvantage might be offset by relaxed alignment tolerances.

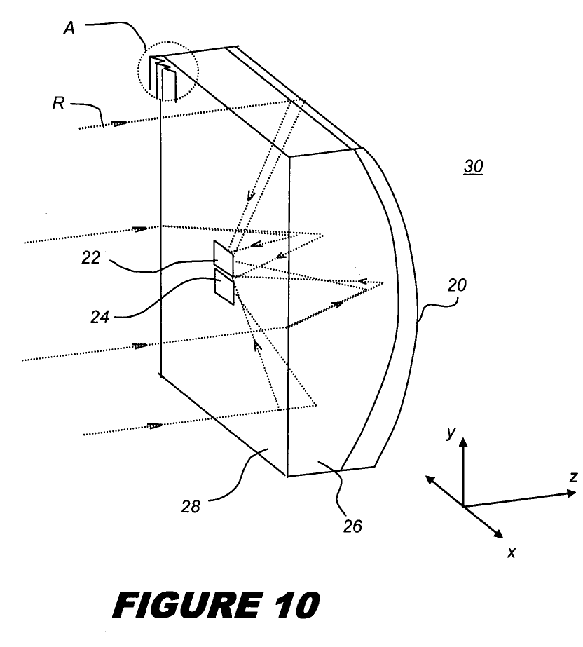

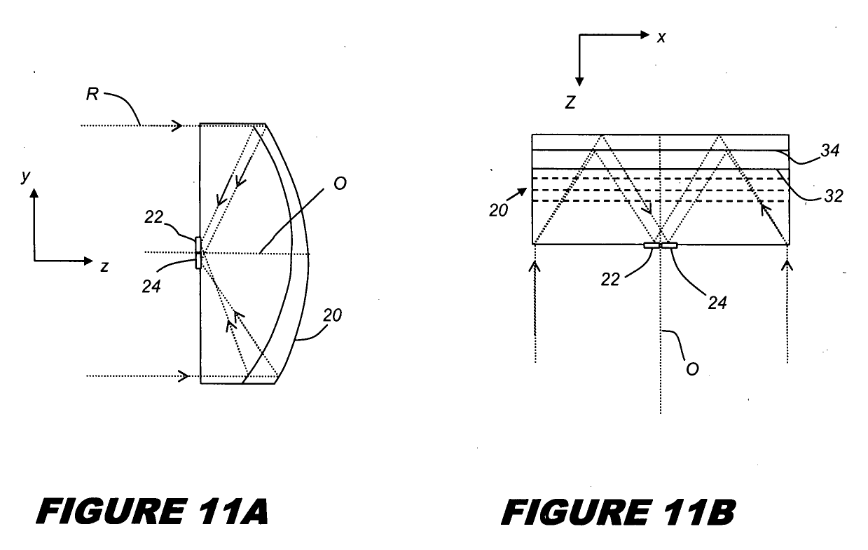

There may also be advantages to embodiments that have optical power along more than one orthogonal axis. Referring to FIG. 10, there is shown a perspective view of an embodiment of anamorphic light collector 30 with optical power along two orthogonal axes and with spectral separation using double parabolic reflector 20. FIG. 11A shows a cross-sectional view of this embodiment with the spectral band separation to each of light receivers 22 and 24; FIG. 11B gives a top view that shows the light concentration with respect to the length of the cylindrical structure (along the x axis). Using the coordinate axes designations given in FIG. 10, this embodiment has optical power with respect to the y axis, that is, in the y-z plane of its parabolic cross-section. In addition, this embodiment has some optical power along the x-axis direction, that is, in the x-z plane. Condensing optical power along the x-axis direction can be obtained by forming front surface 28 as correspondingly convex with respect to incident light rays R. Alternately, optical power in the x-z plane can be obtained by the employment of a Fresnel lens structure on surface 28, as shown within area A in FIG. 10. Yet another way to employ power in the x-axis direction would be to apply a curvature to the parabolic surfaces in the x-z plane thus making them anamorphic. Representative ray traces drawn in FIGS. 10 and 11B show the advantage that is gained with the addition of optical power along the x axis. As one salient advantage, light receivers 22 and 24 can be significantly reduced in overall size from those shown in the cylindrical embodiment of FIG. 8, thereby causing proportionately less obstruction from incident light. Electrical connection can be made to receivers 22 and 24 in a number of ways, including an electrode extending along only part of front face 28. Electrical connection can also be made internally or through the curved surface, with minimum obstruction, as described subsequently. Another significant advantage of embodiments such as that shown in FIG. 10, that have some power in the x-z plane, relates to tolerance trade-offs when tracking the relative position of the sun, as described subsequently.

Array Embodiments

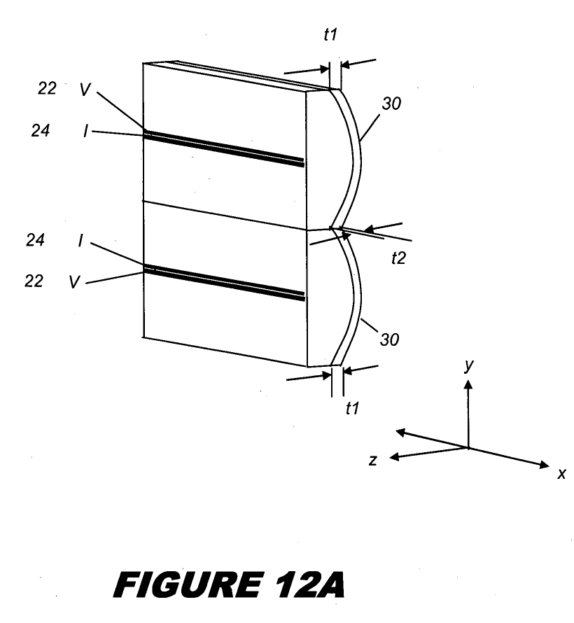

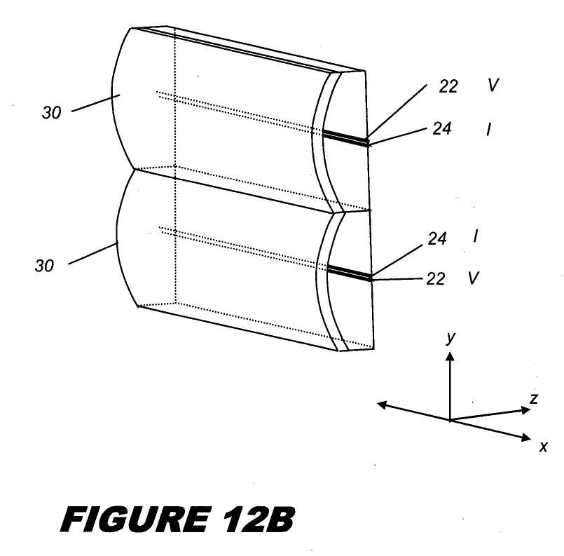

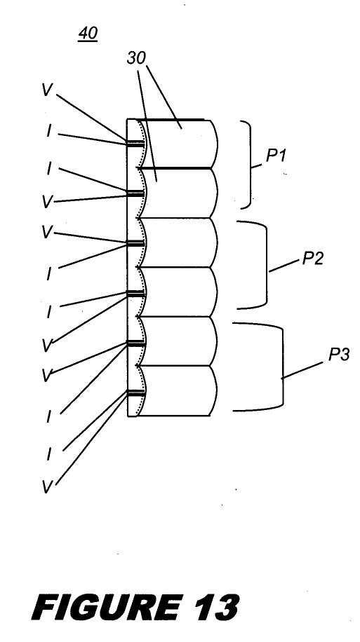

Cylindrical light concentrator 30 design is particularly well-suited to array embodiments. For reasons related largely to manufacturability, the patterned arrangement of paired light concentrators 30 shown in FIGS. 12A and 12B is particularly advantaged. As was described with reference to the decentered embodiment of FIG. 5, thicknesses t1 and t2 at opposite top and bottom edges of double parabolic reflector 20 may be different. For this reason, it can be advantageous to fabricate light concentrators 30 in pairs so that the intersection between adjacent light concentrators 30 has matching thicknesses of their corresponding double parabolic reflectors 20. As shown in FIGS. 12A and 12B, this means that one light concentrator 30 is flipped so that it is vertically mirrored with respect to the other. In the embodiment shown, the paired adjacent light concentrators 30 are arranged so that thicknesses t2 are adjacent. This means that first and second light receivers 22 and 24 also have a particular pattern. In the arrangement shown, first light receiver 22 receives visible light (V), second light receiver 24 receives IR light (I). Thus, the arrangement has the pattern V-I-I-V for the paired light concentrators 30 of FIGS. 12A and 12B. The perspective view of FIG. 13 shows a portion of an array 40 of light concentrators 30, with three pairs, P1, P2, and P3, with the type of light directed to light receivers 22 and 24 again represented by V-I-I-V-V-I-I-V-V-I-I-V. Of course, while the arrangement shown in FIGS. 12A, 12B, and 13 is advantaged for fabrication of array 40 in this embodiment, alternate patterns could be used.

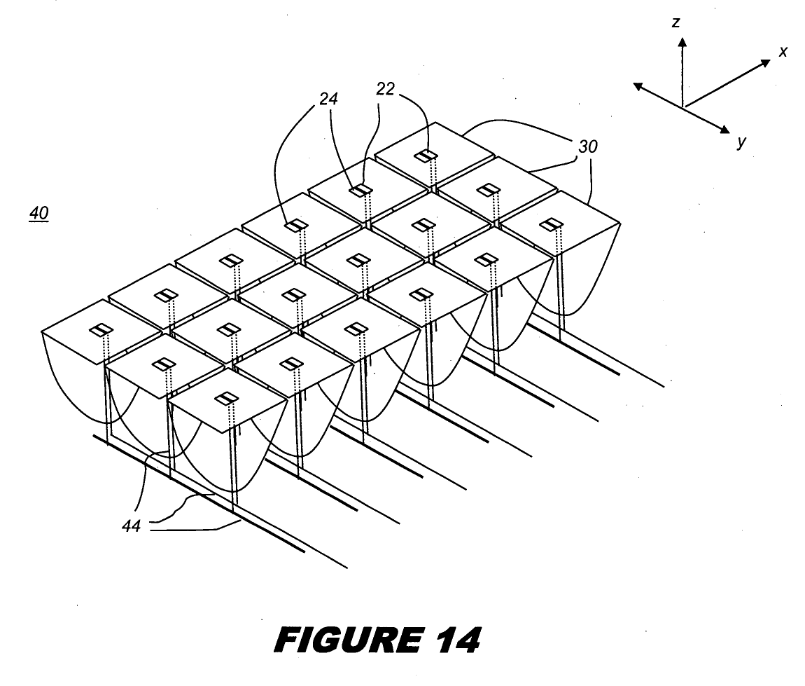

Array 40 can thus be formed from two or more cylindrical segments of light concentrators 30 of varying length, as needed in an individual application. An array can also be formed using one or more rows of rotationally symmetric light concentrators 30. FIG. 14 shows an embodiment of array 40 with multiple rows of light concentrators 30 of the rotationally symmetric type. It can be observed that one or more connecting electrodes 44 extend to each light concentrator 30. To minimize the amount of additional obstruction due to electrodes 44, the embodiment of FIG. 14 has electrodes 44 extending into each light concentrator 30 from the side opposite the sun or other radiant energy source. As described earlier, this portion of light concentrator 30 has the obstruction presented by light receivers 22 and 24.

Depending on the layout geometry used for array 40, the rotationally symmetric arrangement of light concentrators 30 can also be disadvantaged due to a reduced fill factor. Packing of light concentrators 30 in “honeycomb” or other layout arrangements may help to alleviate loss of fill factor. Modifications to a rotationally symmetric shape for reflective curved surfaces can also help to alleviate this fill factor shortcoming, but the resulting modified shapes may not provide the full advantages of light concentration from a reflective paraboloid.

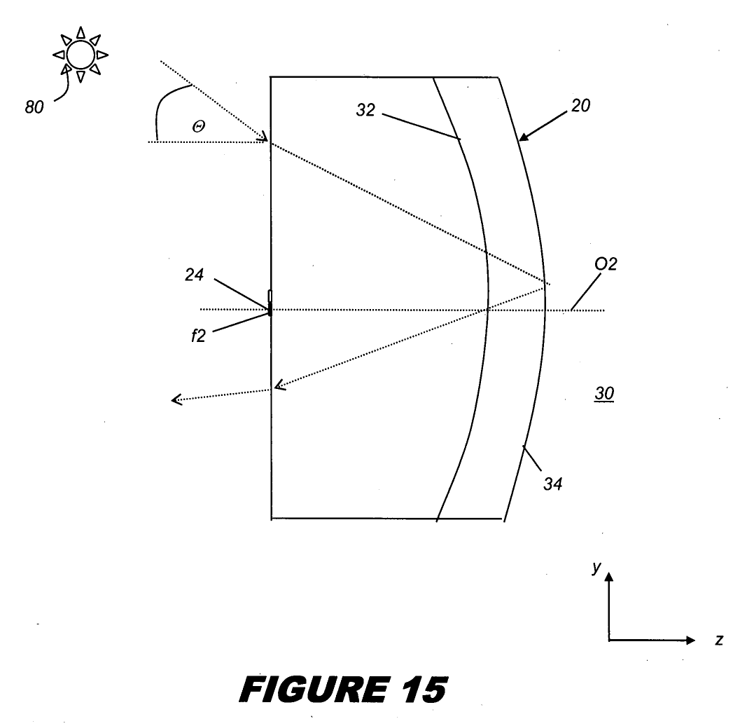

Light concentrator 30 provides a highly efficient system for obtaining radiant energy. However, like most devices used as solar light collectors, there are some limitations related to light angle. Referring to the side view of FIG. 15, incident light at higher angles can be reflected away from the light receiver 24 at the focal region f2. Here, light at angle θ is at a high angle with respect to the optical axis O2 and some amount of coma results. To make most efficient use of sunlight, for example, the optical axis should be directed toward the sun. Tracking apparatus, described subsequently, can be used to improve efficiency by properly aligning light concentrator 30.

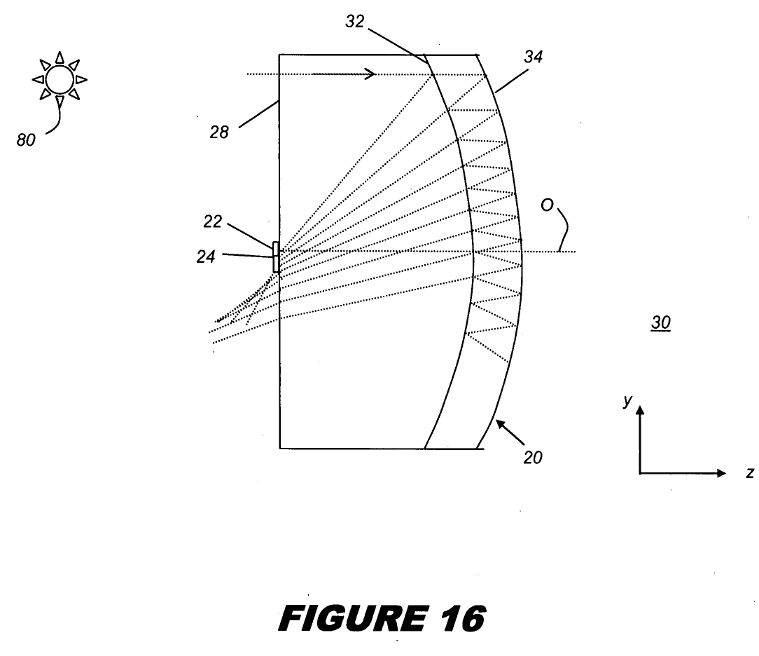

The side view of FIG. 16 shows other possible causes for lost energy. Some amount of Fresnel reflection at front surface 28 and absorption within body 26 can account for lost efficiency. In addition, even though dichroic surfaces are highly efficient, some small percentage of light leakage will occur. Thus, for example, some small amount of visible light is transmitted through the dichroic coating of first curved reflective surface 32. Much of this misdirected light can remain “trapped” between second and first curved reflective surfaces 34, 32. Some portion of this light can be transmitted back through first curved reflected surface 32; however, this light is likely to be directed to the wrong light receiver 24 or directed away from either light receiver 22 or 24.

Anamorphic Light Concentrator Embodiments

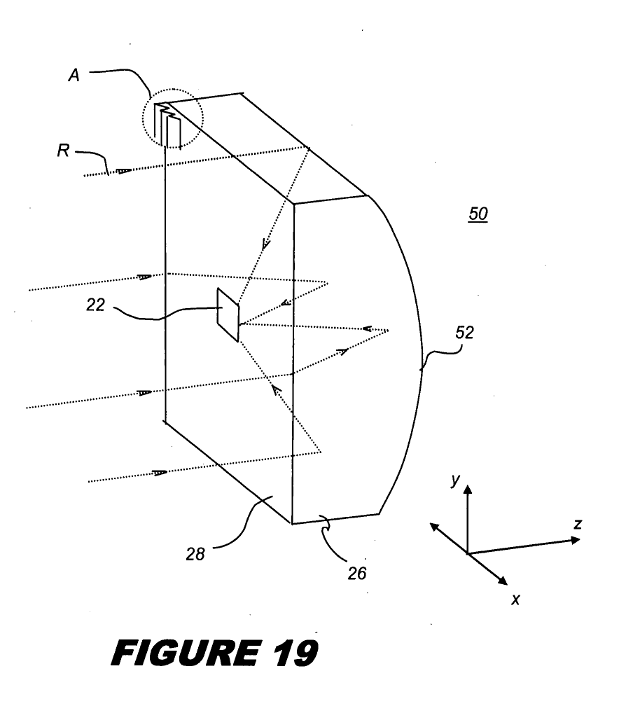

For some applications, such as where stacked photovoltaic devices are used, spectral separation may not be a requirement. The perspective view of FIG. 19 shows an anamorphic light concentrator 50 in an embodiment in which body 26 has a single light receiver 22 and a curved reflective surface 52, concave with respect to incident light. In this embodiment, reflective surface 52 has optical power in the y-z plane and front surface 28 has optical power in the orthogonal x-z plane. Optical power in the x-z plane may be provided by Fresnel lens structure, as shown in area A, or by curvature of front surface 28. Light rays R are thus directed toward light receiver 22, disposed near the focal region of curved reflective surface 52. This arrangement provides improved anamorphic light concentration, without the added spectral separation described with reference to FIG. 10. It allows an arrangement of light concentrators 50 that are extended linearly but do not require the linear arrangement of light receiver components shown, for example, in the embodiments of FIGS. 8, 12A, and 12B. Thus receivers 22 can be spaced periodically along each row of light concentrator 50 instead of being continuously extended.

Orientation with Respect to the Radiation Source

As was described with reference to FIG. 15, in order to efficiently obtain and concentrate light from the sun 80 or other radiation source, it is important that light concentrator 30 be properly oriented with respect to the source. With a discrete system, such as where body 26 is in the form of a rotationally symmetric device having close parallel optical axes O1, O2, light-gathering efficiency is optimized simply by aligning these optical axes toward the sun 80 or other radiation source. With a cylindrical embodiment, however, device orientation can be more forgiving along the East-West axis. The North-South-East-West (abbreviated N, S, E, W) orientation of this component directly affects its capability for obtaining and concentrating radiant energy. For reference, the N, S, E, W orientation is shown relative to the xyz coordinate mapping used in preceding description.

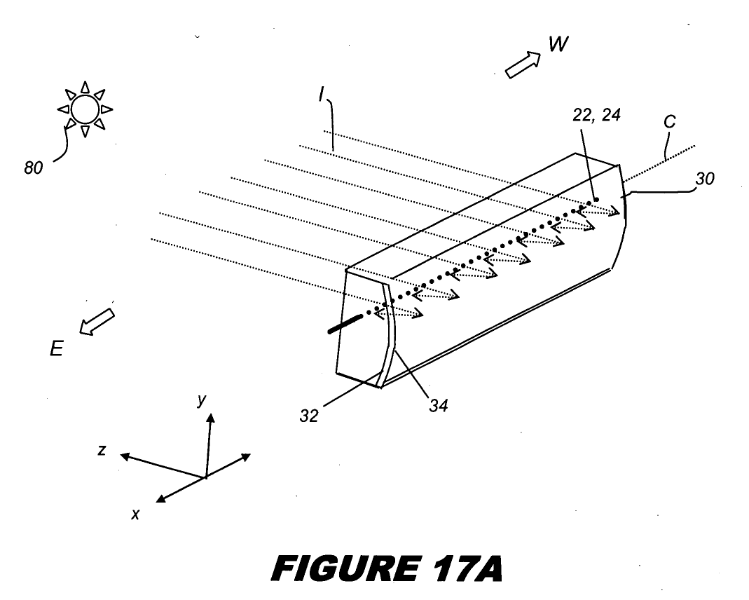

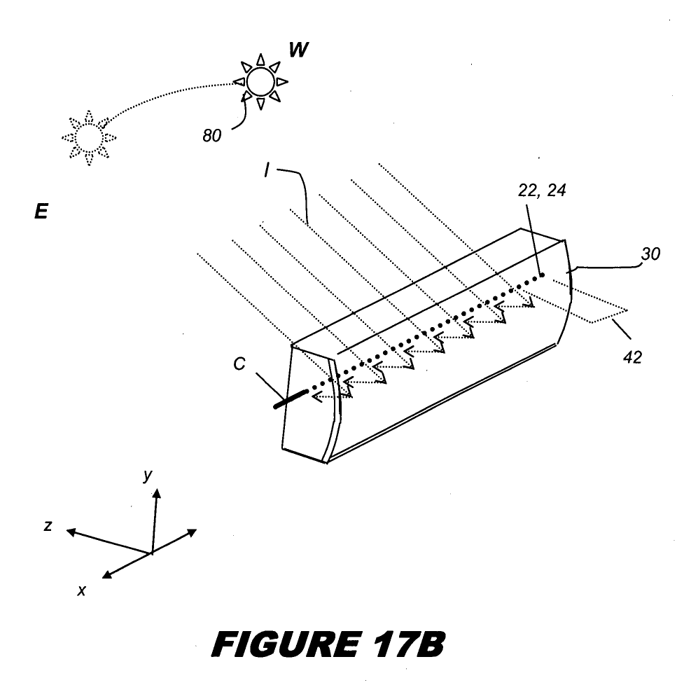

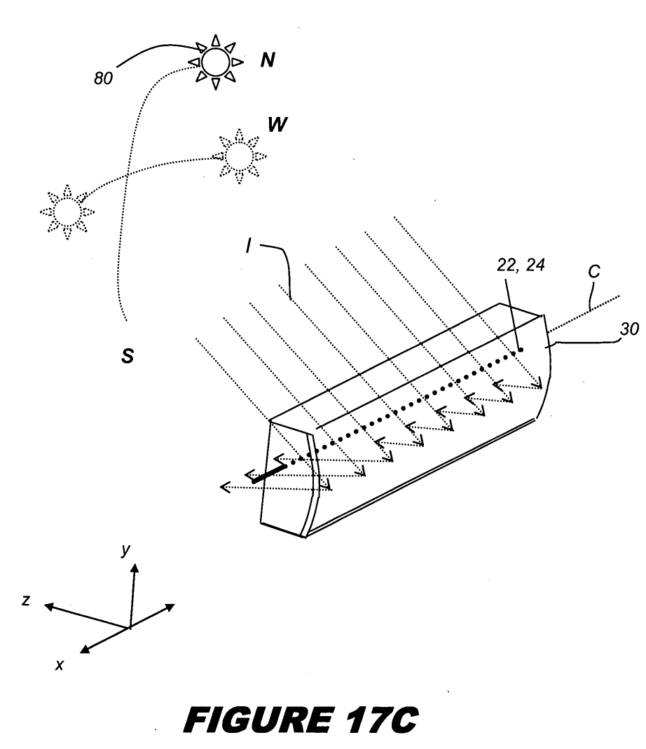

The perspective views of FIGS. 17A, 17B, and 17C show the light-gathering behavior of light concentrator 30 in a cylindrical embodiment, relative to the E-W and N-S direction of the radiation source. In FIG. 17A, the cylindrical axis C of light concentrator 30 is generally aligned in parallel with an E-W axis. When optimally oriented toward the sun 80 or other radiation source, light concentrator 30 obtains the optimum amount of light along the full length of its light receivers 22 and 24.

FIG. 17B shows what happens when light collector 30 is no longer optimally oriented with respect to the E-W axis. Only a partial length of light receivers 22 and 24 receives focused light. A portion 42 can be missed. However, a substantial amount of the light is still incident on light receivers 22 and 24. Thus, light concentrator 30 functions, at some level of efficiency, over a fairly broad field of view in the E-W direction.

The perspective view of FIG. 17C shows the behavior of light concentrator 30 if it is not properly oriented relative to the N-S axis. When inaccurately tilted about its cylindrical axis C, light collector 30 may allow some “walk-off” of light in the vertical direction, more extreme than that shown in FIG. 9C. As was described with reference to FIG. 15, an extreme angle can be unfavorable, so that the proper spectral bands are not directed to their corresponding light receivers 22, 24.

It can be noted that the embodiment shown in FIGS. 10, 11A and 11B, in which light concentrator 30 has optical power in the x direction, can be made inherently more forgiving to N-S sun tracking error, since light receivers 22 and 24 can be made larger with respect to the y direction as shown in FIG. 10. This, however, is at the expense of some measure of the E-W tracking tolerances, since now light in the orthogonal direction is concentrated onto receivers 22 and 24. Poor orientation along the E-W direction can cause “walk-off” that is in a direction orthogonal to that described with reference to FIG. 9C.

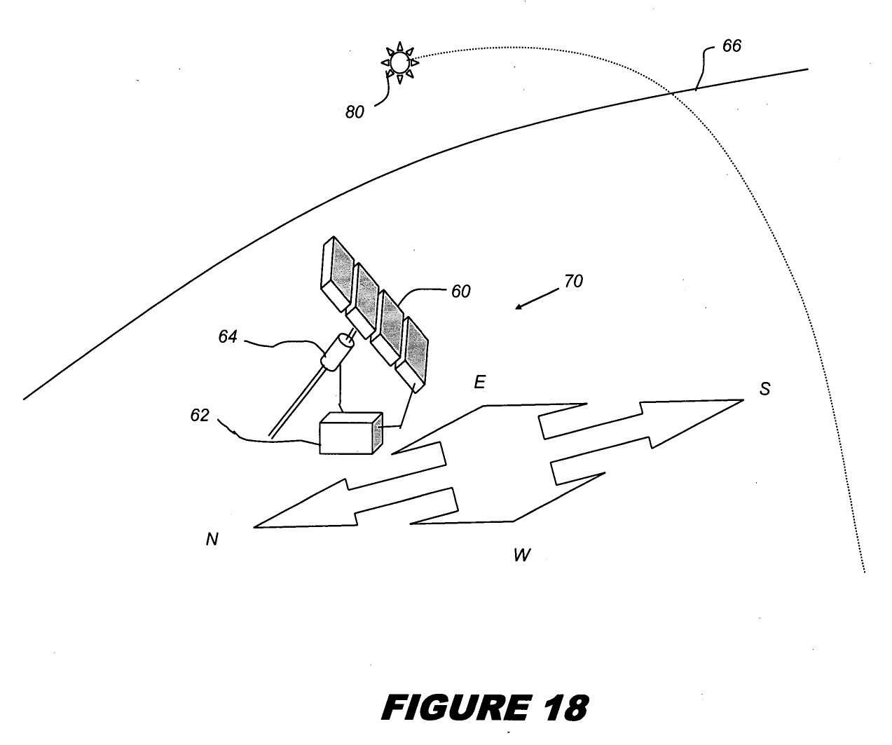

Solar tracking systems and methods are well known and can be readily adapted to use light collector 30, either in discrete or in array form. FIG. 18 shows a solar energy system 70 according to the present invention. One or more radiant energy concentration apparatus 60 is arranged and designed to track the sun 80. A tracking actuator 64 is controlled by a control logic processor 62 to properly orient radiant energy concentration apparatus 60 as the sun's E-W position changes relative to earth 66 throughout the day as well as to make minor adjustments necessary for proper N-S orientation. Control logic processor 62 may be a computer or a dedicated microprocessor-based control apparatus, for example. Control logic processor 62 may sense position by measuring the relative amount of electrical current obtained at a position, or by obtaining some other suitable signal. In response to this signal that is indicative of position, control logic processor 62 then provides a control signal to instruct tracking actuator 64 to make positional adjustments accordingly.

Fabrication

Light concentrator 30 can be formed as a discrete unit or as a cylindrical component as part of an array, as was shown in array 40 in FIG. 13. In an array embodiment, a plurality of light concentrators 30 are assembled alongside each other, optionally using the arrangement of pairs of light concentrators 30 described with reference to FIGS. 12A and 12B. Continuous fabrication of at least a portion of light concentrator 30 can be performed using extrusion. In one array embodiment, an extrusion process forms a ribbed sheet, with parallel lengths of double parabolic reflectors 20 aligned along the sheet. Suitable optical coatings are then applied onto the curved surfaces on each side of the sheet. The prepared sheet is then affixed to a substrate using an epoxy or other suitable adhesive, with air bubbles eliminated in the bonding process. Refractive indices of the different components and adhesives used are closely matched in one embodiment.

To allow optical coupling and minimize total internal reflection (TIR) effects, light receivers 22 and 24 are optically immersed or optically coupled to body 26 using an optical material, such as an optical adhesive, that has an index of refraction that is close to that of body 26. Reflective sides at opposite ends of the cylindrical structure (not shown in FIG. 2, but parallel to the plane of the page in this cross-sectional view) help to prevent light leakage from light concentrator 30 in directions orthogonal to the page.

Its relatively narrow depth allows light concentrator 30 to be suitably scaled for use in a thin panel design. In one thin panel array embodiment, for example, nominal component dimensions for each light concentrator 30 are as follows:

Concentrator cell height: 20 mm

Concentrator cell depth: 10 mm

Adjacent light concentrators 30 may be optically coupled, allowing total internal reflection (TIR) within array 40 for a portion of stray or misdirected light. Rays may undergo TIR and reflection from one or more coated curved reflective surfaces a number of times before either encountering a light receiver 22, 24 in one of light concentrators 30 or exiting array 40 as wasted light.

Light concentrator 30 of the present invention is advantaged over other types of radiant energy concentrator devices, providing both light concentration and spectral separation. Light concentrator 30 of the present invention exhibits only a very small amount of obstruction of incident on-axis light, typically less than 2%, comparing favorably over Cassegrain-type embodiments proposed elsewhere that may obstruct about 10% or more of the on-axis light.

With spectral separation from double parabolic reflector 20, light concentrator 30 enables use of photovoltaic receivers having a lateral, rather than a stacked, arrangement in which separate spectral bands are directed onto suitable photovoltaic cells, each optimized for obtaining light energy from the wavelengths in that spectral band. The apparatus of the present invention can be used to provide a discrete, modular light-concentrating element or an array of light concentrators. The apparatus is scalable and can be adapted to thin panel applications or to larger scale radiant energy apparatus. One or more of light receivers 22 and 24 can be photovoltaic (PV), fabricated from any suitable photovoltaic materials for the spectral bands provided, including silicon, gallium arsenide (GaAs), gallium antimonide (GaSb), and other materials. One or more of light receivers 22 and 24 could alternately be thermovoltaic or thermophotovoltaic (TPV), using some material that converts heat into electricity, including thermoelectric material such as mercury cadmium telluride thermal diodes. One or more of light receivers 22, 24 could be a charge-coupled device (CCD) or other light sensor.

In alternate embodiments, one or more of light receivers 22, 24 serve as the input image plane of another optical subsystem, such as for energy generation or spectral analysis, for example. One or both of light receivers 22, 24 can be an input to a light guide such as an optical fiber, for example.

It can be observed that the two or more spectral bands provided to the light receivers are not sharply spectrally distinct, but will have some overlap, where each spectral band contains some of the same wavelengths. Some amount of spectral contamination would be inevitable, since dichroic response is imperfect and light can be incident at non-normal angles, degrading the performance of the dichroic coating. Dichroic coatings could be optimized in order to reduce spectral contamination to lower levels where desired. As was noted earlier, a dichroic coating could alternately be provided as a treatment for second curved surface 34 instead of a reflective coating of some other type, thus providing improved efficiency over many types of conventional mirror coatings. For any of the embodiments shown hereinabove, spectral bands can be defined and optimized as best suits the requirements of an application.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, while a cylindrical arrangement of light concentrator 30 may be preferred for some applications, there can also be advantages to alternate shapes, such as a toroidal shape. In a toroidal embodiment, there is optical power in multiple planes. There can be advantages to the use of multiple components, such as the addition of a Fresnel lens having optical power in the y direction relative to FIG. 10. This could help to reduce coma, for example. Thus, a light concentrator of the present invention could have two separate Fresnel lenses or Fresnel structures or other suitable lenses or other light concentrating components orthogonally disposed with respect to each other, one for reducing coma, the other for concentrating light orthogonal to the parabolic concentration provided.

It is recognized by those skilled in the optical design arts that some latitude must be allowed for the phrases “near the focal region” or “at the focal region”. Practical optomechanical tolerances allow some variability in precise positioning according to the principles used in this teaching of the present invention. As was noted earlier, precise parabolic or paraboloid surfaces are the ideal reflective surfaces for focus along a line or at a point; however, in practice, only an approximation to a parabolic or paraboloid surface is achieved, but this provides acceptable results in applying the techniques of the present invention.

Thus, what is provided is an apparatus that collects light from the sun or other polychromatic radiation source, optionally separates light into two or more spectral bands, and provides each spectral band to a light receiver.

### PARTS LIST

10. Photovoltaic apparatus
12. Primary mirror
14. Secondary mirror
16. Receiver
20. Double parabolic reflector
22. First light receiver
23. Third light receiver
24. Second light receiver
26. Body
28. Front surface
30. Light concentrator
32. First curved reflective surface
34. Second curved reflective surface
36. Prism
38. Band
40. Array
42. Portion
44. Electrode
50. Light concentrator
52. Light receiver
60. Radiant energy concentration apparatus
62. Control logic processor
64. Tracking actuator
66. Earth
70. Solar energy system
80. Sun
A. Area
C. Cylindrical axis
d. Distance
f1, f2. Focal region
O, O1, O2. Optical axis
R. Ray
t1, t2. Thickness
N, E, S, W. North, East, South, West

We claim:

1. An apparatus for obtaining radiant energy from a polychromatic radiant energy source, the apparatus comprising:
a) a spectral separator comprising:
(i) a first curved surface concave to the incident radiant energy and treated to reflect a first spectral band toward a first focal region and to transmit a second spectral band;
(ii) a second curved surface concave to the incident radiant energy and treated to reflect the second spectral band toward a second focal region;
wherein the first and second curved surfaces are optically positioned so that the first and second focal regions are spaced apart from each other;
and
b) first and second light receivers,
wherein the first light receiver is disposed nearest the first focal region for receiving the first spectral band and the second light receiver is disposed nearest the second focal region for receiving the second spectral band.

2. The apparatus according to claim 1 wherein the first curved surface is treated to reflect visible wavelengths.

3. The apparatus according to claim 1 wherein the first curved surface is treated to reflect infrared wavelengths.

4. The apparatus according to claim 1 wherein the first and second curved surfaces are optically decentered.

5. The apparatus according to claim 1 wherein the first curved surface is substantially parabolic in cross section along at least one axis.

6. The apparatus according to claim 1 wherein the first curved surface has a dichroic coating.

7. The apparatus according to claim 1 wherein the second curved surface has a dichroic coating.

8. The apparatus according to claim 1 wherein at least one of the first and second light receivers is a photovoltaic receiver.

9. The apparatus according to claim 1 wherein at least one of the first and second light receivers is a thermovoltaic receiver.

10. The apparatus according to claim 1 wherein at least one of the first and second light receivers is a charge-coupled device.

11. The apparatus according to claim 1 wherein at least one of the first and second light receivers comprises an optical fiber.

12. The apparatus according to claim 1 wherein at least one of the first and second light receivers is an input plane for another optical system.

13. The apparatus according to claim 1 wherein a substantially transparent optical material lies between the first curved surface and the first focal region.

14. The apparatus according to claim 1 wherein the spectral separator is cylindrical.

15. The apparatus according to claim 1 wherein at least one of the first and second curved surfaces is rotationally symmetric.

16. The apparatus according to claim 1 wherein the first curved surface has a first cross-sectional axis and the second curved surface has a second cross-sectional axis that is noncollinear with the first cross-sectional axis.

17. The apparatus according to claim 1 wherein the spectral separator further comprises a substantially transparent body having a front surface for receiving incident light.

18. The apparatus according to claim 17 wherein the front surface comprises at least one refracting feature.

19. The apparatus according to claim 17 wherein the front surface comprises a lens.

20. The apparatus according to claim 17 wherein the front surface comprises a dispersion element for conditioning incident polychromatic radiant energy to direct a dispersed polychromatic radiation toward the first curved surface.

21. The apparatus according to claim 20 wherein the dispersion element is a prism.

22. The apparatus according to claim 16 wherein the separation distance between the first cross-sectional axis and the second cross-sectional axis is substantially equal to the center-to-center separation distance between first and second light receivers.

23. The apparatus according to claim 16 wherein the first light receiver lies along the first cross-sectional axis and the second light receiver lies along the second cross-sectional axis.

24. The apparatus according to claim 13 wherein the first light receiver is optically immersed in the substantially transparent optical material.

25. The apparatus according to claim 1 further comprising:
c) a dispersive element for dispersing the incident polychromatic radiant energy to form a third spectral band, wherein the third spectral band is also reflected from the first curved surface; and
d) a third light receiver disposed near the first focal region for receiving the third spectral band.

26. The apparatus according to claim 18 wherein the first curved surface has optical power in a first plane and wherein the at least one refractive feature has optical power in a second plane that is orthogonal to the first plane.

27. An apparatus for obtaining radiant energy from a polychromatic radiant energy source, the apparatus comprising:
a) a spectral separator comprising a transparent body having a front surface for receiving the incident radiant energy and further comprising:
(i) an inner curved surface concave to the incident radiant energy and treated to reflect a first spectral band toward a first focal region and to transmit a second spectral band;
(ii) an outer curved surface concave to the incident radiant energy and treated to reflect the second spectral band toward a second focal region;
wherein the inner and outer curved surfaces are optically disposed so that the first and second focal regions are separated from each other by a non-zero distance;
and
b) first and second light receivers spaced apart from the inner and outer curved surfaces, wherein the first light receiver is disposed nearest the first focal region for receiving the first spectral band and the second light receiver is disposed nearest the second focal region for receiving the second spectral band.

28. The apparatus according to claim 27 wherein the front surface is featured to provide optical power in the same plane as the optical power provided by the inner and outer curved surfaces.

29. The apparatus according to claim 27 wherein the front surface is featured to provide optical power in a plane orthogonal to the plane of the optical power provided by the inner and outer curved surfaces.

30. The apparatus according to claim 27 wherein the front surface further comprises a dispersive element for dispersing the incident polychromatic radiant energy to form a third spectral band, wherein the third spectral band is also reflected from the inner curved surface and further comprising a third light receiver spaced apart from the inner and outer curved surfaces for receiving the third spectral band.

31. An apparatus for obtaining radiant energy from a polychromatic radiant energy source, the apparatus comprising:
a) a dispersive surface for providing dispersion to incident polychromatic radiant energy, forming a dispersed incident polychromatic radiant energy thereby;
b) a spectral separator comprising:
(i) a first curved surface concave to the incident radiant energy and treated to reflect a first spectral band of the dispersed incident polychromatic radiant energy toward a first focal region and to transmit a second spectral band;
(ii) a second curved surface concave to the incident radiant energy and treated to reflect the second spectral band toward a second focal region;
wherein the first and second curved surfaces are optically positioned so that the first and second focal regions are spaced apart from each other;
c) a first light receiver disposed near the first focal region for receiving a first spectral portion of the first spectral band;
d) a third light receiver disposed near the first focal region for receiving a second spectral portion of the first spectral band;
and
e) a second light receiver disposed near the second focal region for receiving the second spectral band.

32. An apparatus for obtaining radiant energy comprising at least two radiation concentrators, wherein each radiation concentrator comprises:
a) a spectral separator comprising a transparent body having a front surface for receiving the incident radiant energy and further comprising:
(i) an inner curved surface concave to the incident radiant energy and treated to reflect a first spectral band toward a first focal region and to transmit a second spectral band;
(ii) an outer curved surface concave to the incident radiant energy and treated to reflect the second spectral band toward a second focal region;
wherein the inner and outer curved surfaces are optically disposed so that the first and second focal regions are spaced apart from each other;
and
b) first and second light receivers spaced apart from the inner and outer curved surfaces, wherein the first light receiver is disposed nearest the first focal region for receiving the first spectral band and the second light receiver is disposed nearest the second focal region for receiving the second spectral band.

33. The apparatus according to claim 32 wherein each radiation concentrator is extended in the direction orthogonal to the direction of its highest optical power.

34. The apparatus of claim 33 wherein, for any two adjacent radiation concentrators either:
the first light receivers of each of the adjacent radiation concentrators are closest together;
or, the second light receivers of each of the adjacent radiation concentrators are closest together.

35. An anamorphic concentrator for radiant energy comprising:
a) an optical body formed from a substantially transparent material, the optical body having:
i) a front surface for accepting incident light;
ii) a curved reflective surface opposite the front surface and concave to the incident radiant energy, the curved reflective surface having a higher optical power in a first plane and having a lower optical power in a second plane that is orthogonal to the first plane,
the curved reflective surface treated to reflect light toward a focal region near the front surface;
and
b) at least one light receiver disposed near the focal region of the curved reflective surface.

36. The anamorphic concentrator of claim 35 wherein the front surface is flat.

37. The anamorphic concentrator of claim 35 wherein the front surface has optical power in a plane orthogonal to the first plane.

38. The anamorphic concentrator of claim 37 wherein the front surface has a plurality of Fresnel lens features.

39. The anamorphic concentrator of claim 37 wherein the front surface has a curvature.

40. The anamorphic concentrator of claim 35 wherein the at least one light receiver is a stacked photovoltaic cell.

41. The anamorphic concentrator of claim 35 wherein the at least one light receiver is optically immersed in the optical body.

42. The anamorphic concentrator of claim 35 wherein the optical body is toroidal.
